(19) United States
(12) Patent Application Publication
(10) Pub. No.: US 2014/0156467 A1
(43) Pub. Date: Jun. 5, 2014

(54) APPLICATION/CONTENT BUNDLING AND MONETIZATION PLATFORM

(71) Applicant: Kachingle, Inc., Sunnyvale, CA (US)

(72) Inventors: Cynthia Typaldos, Palo Alto, CA (US); Frank Spies, Menlo Park, CA (US); Paul Frederic Ranft, Remscheid (DE)

(73) Assignee: Kachingle, Inc., Sunnyvale, CA (US)

(21) Appl. No.: 14/030,724

(22) Filed: Sep. 18, 2013

Related U.S. Application Data
(60) Provisional application No. 61/702,696, filed on Sep. 18, 2012.

(51) Int. Cl. G06Q 30/06

(52) U.S. Cl. CPC G06Q 30/0635
USPC 705/26.81

(57) ABSTRACT

Based on submitted software applications, a management system can combine two or more software applications into a bundle that provides users access to the software applications included in the software application bundle. Access to the software applications, including type of access, duration of access, etc., is controlled by financial terms or other credits associated by the management system with the selected software application bundle, such as a monthly subscription fee. Once users are provided access to various software applications, the users and respective publishers may capture various use events related to accessing one or more software applications. After collecting use information, the management system can then initiate a reconciliation event.

### CROSS-REFERENCE TO RELATED APPLICATION

This application claims the benefit of U.S. Provisional Patent Application No. 61/702,696, filed Sep. 18, 2012, the entirety of which is incorporated herein by reference.

### BACKGROUND

Generally described, computing devices and communication networks facilitate the collection and exchange of information. In a common application, computing devices, such as personal computing devices, can utilize a wide area communication network, generally referred to as the Internet, to access content or other data from other computing devices associated with content providing entities. The type of content exchanged between the computing devices can vary according to the specific design/function of the computing device and the type of content provided by the content providing entity.

Users can request data from a content providing entity that is delivered to one or more computing devices. For example, users can transmit a request, or initiate a transaction, that results in the downloading or streaming of content to a computing device. Typically, the content providing entity would initiate such a transfer upon receipt of the request from the computing device. Additionally, the content providing entity may require some type of compensation or credit in response to providing the requesting user access to the content.

Individual users can identify appropriate content providing entities in a number of ways. In one aspect, users can conduct searches via the communication network or other resources to identify appropriate content providing entities and initiate content requests. For example, a user may access a network resource, such as Web page, configured specifically to offer content for specific types of computing devices, operating systems, software applications, and the like. The specifically configured network resources are often referred to as “marketplaces” or “stores.” Depending on the type of content providing entity involved, the results of such user initiated searches can vary. As such, a user may have difficulty identifying content providers that can provide specific content. Additionally, a user may have difficulty selecting from a group of content providers that are known to provide specified content. Similarly, content providers/content publishers may have difficulty identifying users interested in obtaining content or otherwise targeting specific classes of users or user types.

In many industries, users may be reluctant to pay for software applications, content and services. Specifically, users may be hesitant to pay full price for access to a software application that may be used infrequently or for a software application in which the user is not confident regarding performance characteristics. For many publishers of content, low volume sales of software applications may limit the distribution and maintenance of the software application.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a block diagram illustrative of a management environment for use in facilitating the sharing of published content;

FIG. 2 is a block diagram of the management environment of FIG. 1 illustrating the provisioning of software applications for use in software application bundles;

FIGS. 3A-3C are block diagrams of the management environment of FIG. 1 illustrating various embodiments for accessing software application bundles;

FIG. 4 is a block diagram of the management environment of FIG. 1 illustrating the creation of custom software application bundles;

FIG. 5 is a flow diagram of software application management processing routine implemented by a management system;

FIG. 6 is a flow diagram of a custom software application bundle creation routine implemented by a management system;

FIG. 7 is a block diagram illustrative of screen display for facilitating the management of software applications in a custom software application bundle; and

FIG. 8 is a block diagram illustrative of a screen display for facilitating the management of software applications in an enterprise software application bundle.

### DETAILED DESCRIPTION

Generally described, the present application is directed to an environment for sharing information. Specifically, the present application is directed toward an environment for facilitating the management of content or physical items, such as software applications, executable code and the like, for use by users. In accordance with an illustrative embodiment, a management system facilitates a software application exchange by accepting software applications from publishers or other content providers. Additionally, the management system accepts software application specifications or license terms from the publishers that can specify recommended terms for use of the submitted software applications in software application bundles.

Based on the submitted software applications, the management system can combine two or more software applications into a logical bundle that provides users access to the software applications included in the bundle. Illustratively, access to the software applications, including type of access, duration of access, etc., is controlled by financial terms or other credits associated by the management system with the selected software application bundle, such as a monthly subscription fee. Additionally, in some embodiments, users may have the ability to modify one or more software applications that can be accessed, or the terms of access, via the software application bundle as part of the financial terms or other credits.

Once users are provided access to various software applications, the users and respective publishers may capture various use events related to accessing one or more software applications. For example, use events can include various access events, access times, accessed file types or file sizes, and the like. After collecting use information, the management system can then initiate a reconciliation event, such as at the expiration of a monthly subscription period. Illustratively, a reconciliation event can include the allocation of at least a portion of the financial compensation, e.g., the monthly subscription fee, between the publishers of the software application bundle. Additionally, in some embodiments, the allocation of the financial compensation in the reconciliation event can include allocating the financial compensation to each publisher based on different distribution or compensation programs. For example, within one software application one or more software applications may be subject to a fixed fee distribution program, one or more software applications may be subject to a pro-rata per use distribution program and one or more software applications may be subject to an average pro-rate per use distribution program. Based on the determined allocation, the management system then causes the reconciliation with each publisher.

Although the present application will be described with regard to specific system configurations, system components, illustrative interaction, and illustrative downloadable content, one skilled in the relevant art will appreciate that the embodiments disclosed are illustrative in nature and should not be construed as limiting. Specifically, an illustrative management environment will be described with regard to the distribution of software applications by publishers, which can include executable code or content. However, the present application is not limited to any specific type of software application or other information that can be transmitted in a communication network. Accordingly, reference to software application or applications is illustrative in nature and should not be construed as limiting. Still further, embodiments of the present application may also be applied with regard to the exchange tangible items. In such embodiments, the illustrative interactions, flow diagrams and screen displays of the present application may also be applied in the context of tangible items.

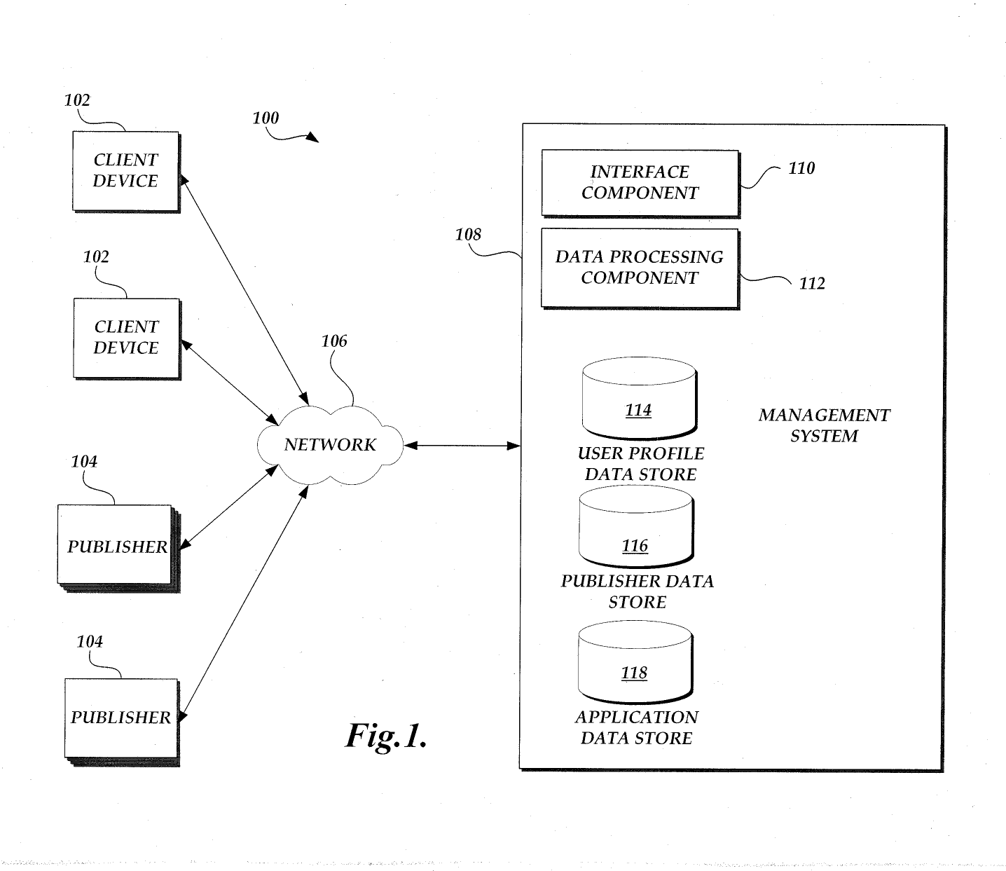

FIG. 1 is a block diagram illustrative of a management environment 100 for facilitating the sharing of content, such as software applications. As illustrated in FIG. 1, the management environment 100 includes a number of client devices 102. As will be described below, each client device 102 logically corresponds to a collection of one or more users that can individually access information via a computing device and a communication network. Client devices 102 can correspond to any one of a variety of computing devices, such as desktop computing devices, mobile devices, tablet devices, embedded devise, and the like, that are configured to interact with the other components of the management environment 100 via a communication network 106. By way of example, the communication network 106 may be, for instance, a wide area network (WAN), a local area network (LAN), or a global communications network.

The management environment 100 can also include one or more publishers 104 for generating content, such as software applications or other executable code. The content publishers 104 provide the content for delivery to the user of the client device 102 via the communication network 106. Each publisher 104 may not correspond to any particular physical network of computing devices. Rather, at least some content providers 104 can relate to logical grouping of individual computing devices without any relation to the physical configuration or physical communication networking of the logically grouped computing devices. Illustratively, publishers can correspond to any number of parties, including entities that generate content, third-party distributors, third-party resellers, individual resellers and the like. Additionally, publisher 104 can also include one or more computing device components for transmitting requested content, causing the shipment of tangible items and reporting usage data as described below.

With continued reference to FIG. 1, the management environment 100 includes a management system 108 for facilitating the interaction between publishers 104 and client devices 102. Illustratively, the management system 108 may be associated with computing resources such as central processing units and architectures, memory (e.g., RAM), mass storage or persistent memory, graphics processing units, communication network availability and bandwidth, etc. Generally, however, the management system 108 may include one or more processing units, such as one or more CPUs. The management system 108 may also include system memory, which may correspond to any combination of volatile or non-volatile storage mechanisms. The system memory may store information that provides an operating system component, various program modules, program data or other components. The management system 108 performs functions by using the processing unit(s) to execute instructions provided by the system memory. The management system 108 may also include one or more types of removable storage and one or more types of non-removable storage. Still further, the management system 108 can include communication components for facilitating communication via wired and wireless communication networks, such as communication network 106.

As illustrated in FIG. 1, the management system 108 can include, among other hardware or software components, an interface component 110 for facilitating the interaction with various components of the management network. In one aspect, the interface component 110 can include one or more interfaces for interacting with client devices 102 to obtain selection of software application bundles or the configuration of custom software application bundles. In another aspect, the interface component 100 can include one or more interfaces for interacting with publishers 104 to obtain the registration of software applications for inclusion in software application bundles and to receive usage data regarding the utilization of software applications. In still another aspect, the interface component 110 can include one or more interfaces for interacting with third-party service providers, such as financial institutions, with regard to reconciliation events. The management system 108 also includes a data processing component 112 for processing software application requests from users and generating specific software application bundles responsive to the request or creating custom software application bundles.

The management system 108 can utilize a user profile data store 114 for maintaining individual user profiles regarding financial compensation (e.g., subscription fees, account numbers, etc.), client identifiers, client preferences, and the like. The management system can also include a publisher data store 116 for maintaining publisher profiles that will be applied to, or correspond to, the software applications included in various software application bundles. The management system 108 can further include an application data store 118 for maintaining information about software applications or software application bundles.

One skilled in the relevant art will appreciate that the data stores illustrated in FIG. 1 may be maintained in a single data store or distributed among several data stores. Additionally, one or more of the data stores may be implemented as network-based services accessible via the communication network, such as via an Application Programming Interface (“API”). Additionally, although the management system 108 is illustrated as a grouping of components and data stores, one skilled in the relevant art will appreciate that the one or more aspects of the management system 108 may be distributed.

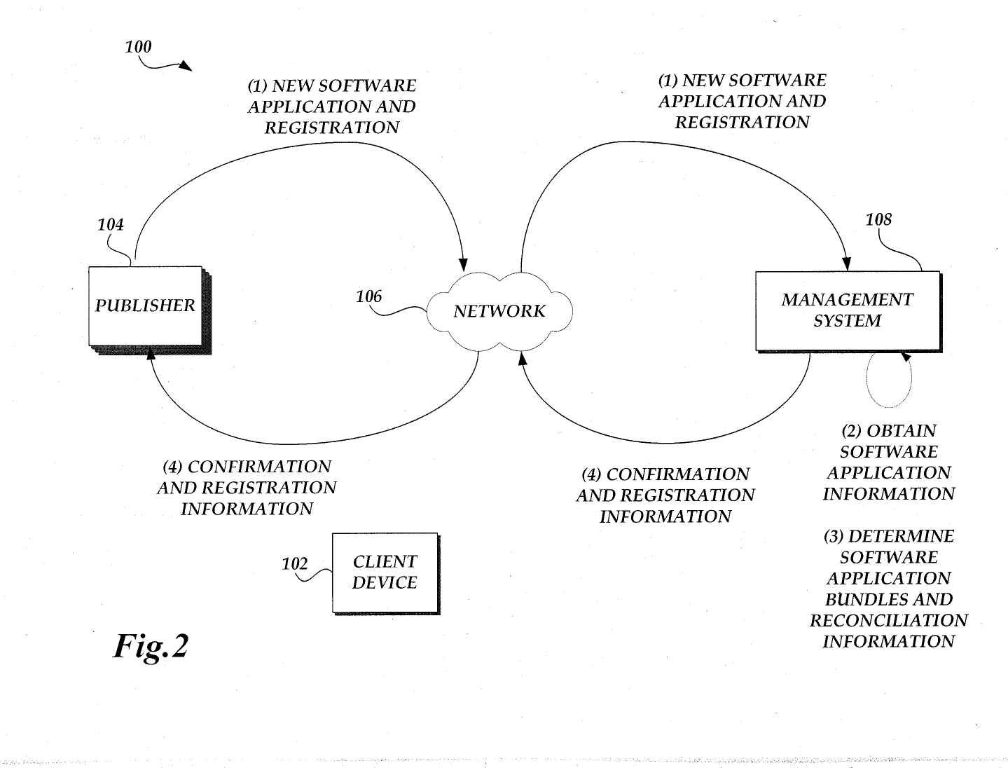

With reference now to FIG. 2, an illustrative interaction between the management system 108 and publishers 104 will be described. At (1), a publisher 104 transmits a request to submit a software application for inclusion in one or more software application bundles. Illustratively, the request can include an identification of the software application and configuration information regarding the application. For example, the request to include the software application can include a description of the software application, identify computability issues, including bundling preferences and include one or more keywords or category descriptors to assist in the association of the software application into one or more software application bundles. In one embodiment, the publisher 104 can provide access to the software application to the client device 102 by downloading executable code or content. In another embodiment, the publisher 104 can provide access to the software application to the client device 102 by providing network-based access to the client device 102. In a further embodiment, the publisher 104 can provide access to the software application to the client device 102 by allowing modified terms for network-based access to the client device 102. In this example, the software application may be available to the client device 102 independent of the inclusion of the software application in the software application bundle. However, the publisher may modify the terms of access (e.g., longer access times, enhanced content, etc.) by inclusion of the software application in the software application bundle. In addition to the information regarding the software application, the request transmitted by the publisher 104 can also include information identifying financial information to be utilized to allocate the software application.

Illustratively, each software application included in a software application can correspond to at least one distribution program or reconciliation program that is used by the management system 108 to make distributions of monetary amounts, credits, points, tokens etc. In one aspect, a distribution program can correspond to a set fixed fee or fixed fee schedule for inclusion of a software application in a software application bundle. In one embodiment, the fixed fee can be considered independent on the number of times a software application is accessed or utilized. In another embodiment, the fixed fee may be subject to various thresholds based on use or access. In still another embodiment, the fixed fee can correspond to no fees. In another aspect, another distribution program can correspond to a pro-rate distribution of funds to be distributed based a measure of utilization, including a determined number of times a software application is accessed, an amount of time a software application is accessed, a total amount of data that is accessed or transmitted and the like. The measure of utilization may be processed in a manner that allows for the application of scalars, normalization, removal of outliers or protection against fraud. In still another aspect, another distribution program can correspond to a pro-rate distribution of funds to be distributed based a measure of utilization of an identified set of software application. The set of software applications may or may not necessarily include the specific software application of the distribution program.

As previously indicated, a software application bundle may be configured such that all included software applications correspond to the same type of distribution program. In another embodiment, the software application bundle may be configured such that at least two of the included software applications correspond to different distribution programs. In this embodiment, the management system 108 can verify and validate that configuration of the software application bundle would still be possible in view of the distribution programs for each included (or proposed) software application. One skilled in the relevant art will appreciate that additional or alternative distribution programs may be practiced in accordance with the present disclosure. For example, the management system 108 may define a specific distribution program to conform to the type of content or tangible items being provided. Additionally, although the above distribution programs have been described in combination, nothing in the present application should be interpreted as requiring any specific type of distribution program or combination of distribution programs.

At (2), the management system 108 obtains and processes the request and obtains any relevant software application information. In one embodiment, the request can include all the relevant information. In another embodiment, the management system 108 can utilize additional information sources, such as a publisher profile to obtain any additional data. At (3), the management system 108 can incorporate the software application into one or more bundles. Illustratively, a software application can be included in multiple software application bundles offered to a user, including custom software application bundles configured by users. Additionally, in some embodiments, the management system 108 can prioritize the utilization of a software application if multiple software application bundles are selected by a user. For example, if a user were to enroll in multiple software application bundles including the same software application, the management system could determine which software application bundle, and its corresponding terms, would be governing on the utilization of the software application.

At (4), the management system 108 transmits a confirmation to the publisher 104. Additionally, in some embodiment, the management system 108 can also transmit additional information, such as API information, publisher identifiers, software application bundle identifiers, and the like that will be utilized to report access or utilization of the software application via a software application bundle. Additionally, in some embodiments, the management system 108 can transmit software code, or portions of software code, that will be utilized by the publisher 104 to determine or calculate access times. For example, the management system 108 can include portions of software code that may be incorporated into a Web page to determine how often a software service or application is accessed via the Web page or other aspects related to the access of the software service or application.

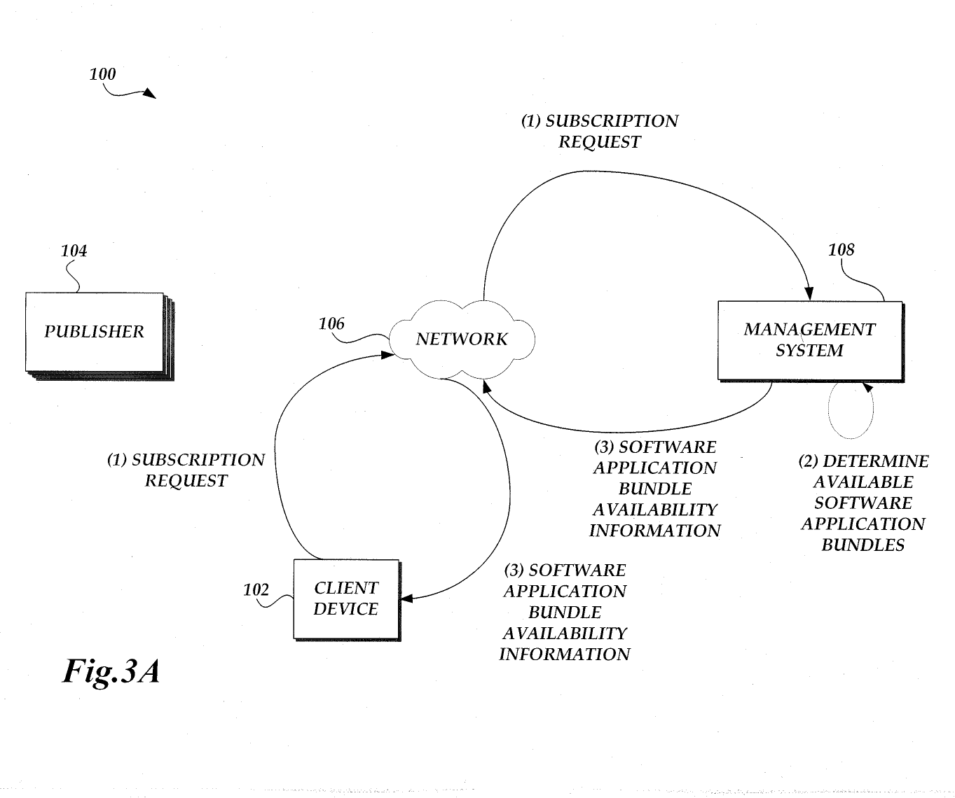

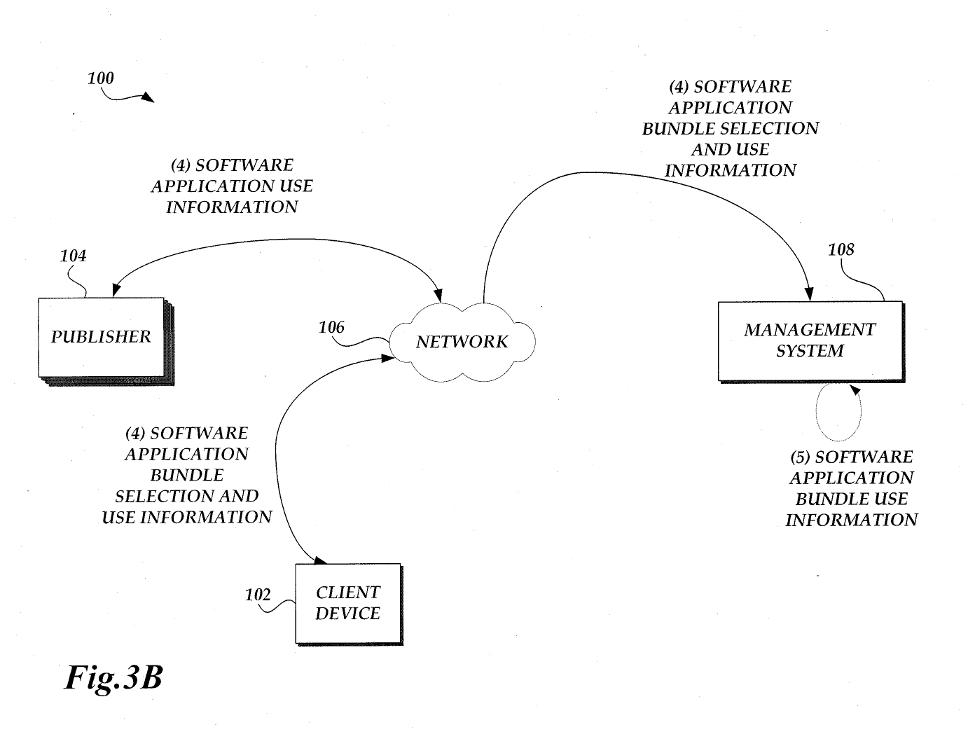

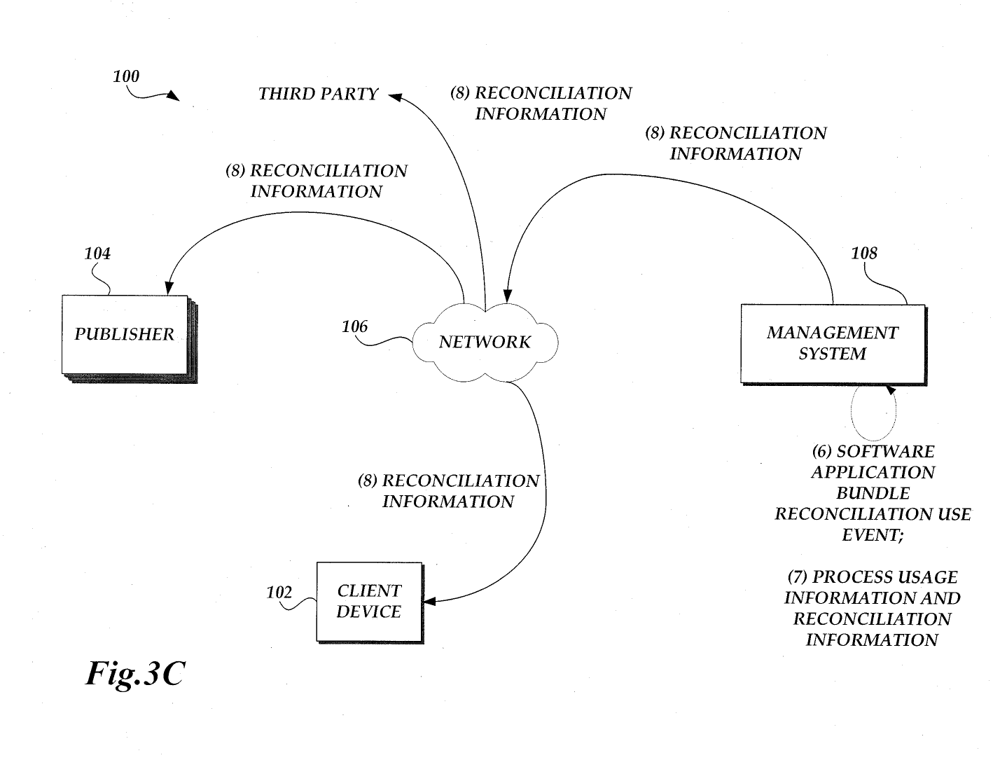

Turning now to FIGS. 3A-3C, an illustrative interaction of a client device 102 will be described. With reference to FIG. 3A, at (1), the client device 102 transmits a subscription request to access the management system 108. The subscription request can correspond to a new subscription request or other request to access content or tangible items facilitated by the management system 108. Alternatively, the subscription request can correspond to a request to modify a pre-existing processed subscription request. Illustratively, the subscription request to access the management system 108 includes the ability for the user, via the client device 102, to add, delete or modify software applications in a software application bundle or add, delete or modify software application bundles.

At (2), the management system 108 processes the request and determines one or more software application bundles that may be made available to the user. Illustratively, the management system 108 can utilize criteria submitted by the client device 102 to identify potential software applications of interest. Additionally, at (3), the management system 108 can utilize information from the user profile data store 114 and publisher data store 116 to identify software application bundles that may be of interest to a user. The identification of software application bundles that may be made available to the user can be embodied in generation of one or more user interfaces, such as a Web page, that identifies specific software application bundles or software application bundle categories/descriptors that can be generated on the client device 102. In another example, the identification of software application bundles that may be made available to the user can be transmitted to the client device 102 in accordance with an API. In such embodiments, the client device 102 may be configured to process the information included in the API to generate interfaces or automate the selection of one or more software application bundles. Illustratively, the presentation of software application bundle information to the client device 102 may involve multiple interactions and may be iterative in nature.

With reference now to FIG. 3B, for purposes of the illustrative example, at (4), the client device 102 transmits a user selection of at least one software application bundle. In some embodiments, a user may be preregistered with the management system 108 such that the user only needs to make a selection. In other embodiments, the selection of at least one software application bundle may also include registration information or information granting access to a user account. FIG. 3B further illustrates that after the selection of a software application bundle, which may be validated by the management system 108, the client device 102 accesses the software application, either directly or indirectly, from the publisher 104. In one example, the client device 102 may communicate with a publisher to access a software application via the communication network 106. In another example, the client device 102 may cause the transmission of software code from the publisher 104 (or entity operating on behalf of the publisher) to the client device 102. In a further example, the client device 102 can send a message to the publisher 104 to elicit some action, such as shipping of tangible items or release of an item.

As further illustrated in FIG. 3B, at (4), the publisher 104 or the client device 102 collects information regarding the access or request for access and transmits the information to the management system 108. As previously discussed, the management system 108 may provide software code, or portions of software code, that facilitate the collection of the use or access information. In some embodiments, both the client device 102 and publisher 104 may transmit user or access information to ensure accuracy or for more complex use information. In still other embodiments, the use or access information may be transmitted to the client device 102 to provide the user with the use or access information being reported by the publisher 104. At (5), the management system 108 obtains the use information.

With reference now to FIG. 3C, at (6), the management system 108 determines a reconciliation event for one or more software application bundles. Illustratively, user access to software application bundles may be defined in terms of monthly subscription fees. Accordingly, in this embodiment, that management system 108 may determine a reconciliation event to correspond to the period of the subscription, e.g., every month. In other embodiments, the management system 108 may determine additional or alternative reconciliation events, such as on fixed calendaring days, upon satisfying a number of use or access events, upon satisfying minimum or maximum thresholds, and the like.

At (7), the management system 108 processes the collected usage information. In one embodiment, that management system 108, can process the collected usage information by applying one or more scalars. In one aspect, the management system 108 can multiple the usage information by a weighting function that can either increase or decrease the number of access events that will be counted. For example, the management system 108 can multiple the number of access events by a scaling factor for software applications determined to be a premium. In another example, the management system 108 can multiple the number of access events by a scaling factor for software applications based on time of day. In another aspect, the management system 108 can apply various filters to determine whether to count access events. In one example, the management system 108 can utilize frequency filters to determine a minimum number of access events that must occur prior to being part of the allocation. In another example, the frequency filters can be utilized to normalize specific outliers in which access events have increased or decreased relative to historical data for the software application or relative to other software applications in the software application bundles. In a further aspect, the management system 108 can utilize other statistical processes, such as normalization, averaging, extrapolation and the like to process the usage information. One skilled in the relevant art will appreciate that additional or alternative processing techniques may also be applied.

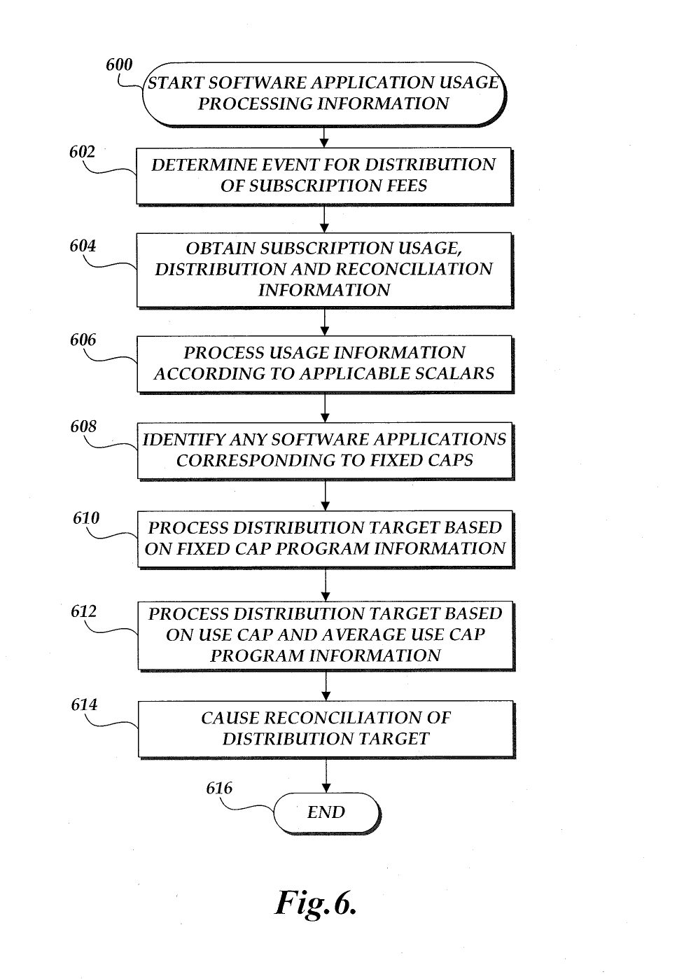

In addition to the processing of the usage data, at (7), the management system 108 determines the appropriate allocation of the distribution amount corresponding to the subscription fee that will be distributed to the publishers 104 in the subscribed software application bundle. Illustratively, the distribution amount can correspond to an amount less than the subscription fee to account for a royalty or percentage retained by the management system 108. The management system 108 can implement various methodologies for processing the distribution amount, one of which will illustratively be discussed with regard to FIG. 6.

At (8), the management system 108 transmits reconciliation information. In one aspect, the management system 108 can transmit the reconciliation information to the publisher 104 to provide them with an accounting of the financial compensation or credits that have been allocated to the publisher. In another aspect, the management system 108 can transmit the reconciliation information to the client device 102 to provide an indication of how the subscription fees were allocated to various publishers 104. In still a further aspect, the management system 108 can transmit the reconciliation information to various third-party providers, such as financial institutions, to cause the reconciliation of financial compensation or credits. In still another aspect, the management system 108 can publish at least portions of the allocation information using various publication services or social networking services, such as to identify popular software applications, popular software application bundles or users of the software application bundles.

In some embodiments, the software application bundles that can be accessed by a client device 102 can be customized by the user of the client device or by an administrator associated with the user. In one example, a user may utilize a fixed compensation amount and determine which software applications are included in software application. In another example, the software application bundles may correspond to enterprise level software applications that are accessed by users affiliated with an organization. In this example, the software application bundles may be standard bundles provided by the management system 108 and funded by the organization. In another example, the software application bundles may be customized by a system administrator or manager associated with the affiliated organization for access by the client devices 102.

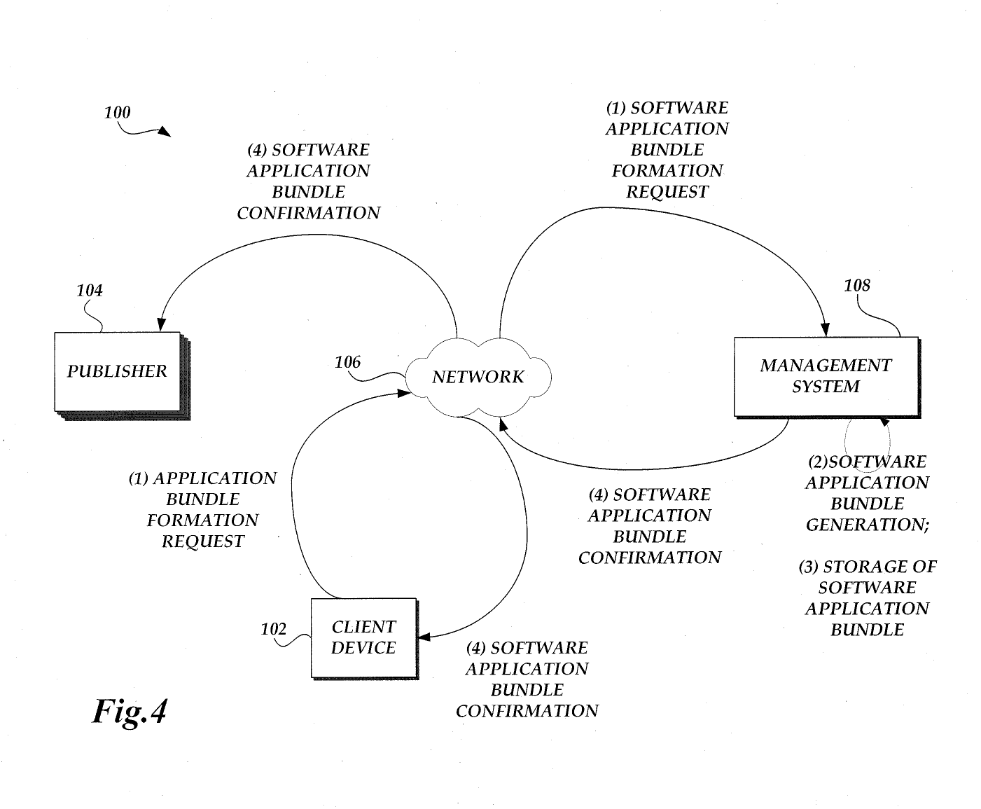

Turning now to FIG. 4, an illustrative interaction for the creation of custom software application bundles will be described. The illustrative interaction illustrated in FIG. 4 may be utilized for individual software application bundle creation or enterprise level software application bundle creation. At (1), the client device 102 transmits a request for generation of an application bundle, such as via an API or a request transmitted to a Web page associated with the management system 108.

At (2), the management system obtains input regarding the creation of software application bundles and creates one or more software application bundles. Illustratively, the creation of software application bundles corresponds to a selection or collection of one or more software applications. Illustratively, a user is first associated with a subscription fee that corresponds, directly or indirectly, to a total sum that can be utilized to select software applications. One or more software applications can then be associated with various costs, such as credits, that are applied against the total sum when the software application is selected to be in a bundle. The management system 108 can determine the cost attributed to each software application based on the reconciliation or distribution program or other criteria. Thus, the management system 108 can prompt a user to add or remove software application or increase subscription fees based on user selections. An illustrative screen display for the management of software applications will be described with regard to FIG. 6.

At (3), the management system 108 stores the created or generated software application bundles. At (4), the management system 108 transmits the software application bundle confirmation. In one embodiment, the management system 108 can transmit the confirmation to the client device 102 and one or more publishers 104 corresponding to the created software application bundle. In another embodiment, the management system 108 can publish the created software application bundle or aspects of the software application bundles to additional persons. For example, the management system 108 can publish the software applications included in a custom software application bundle to be utilized as a template for other users. In another example, the management system 108 can post the custom software application bundle on a Web page so that other users may subscribe (as illustrated in FIG. 3C).

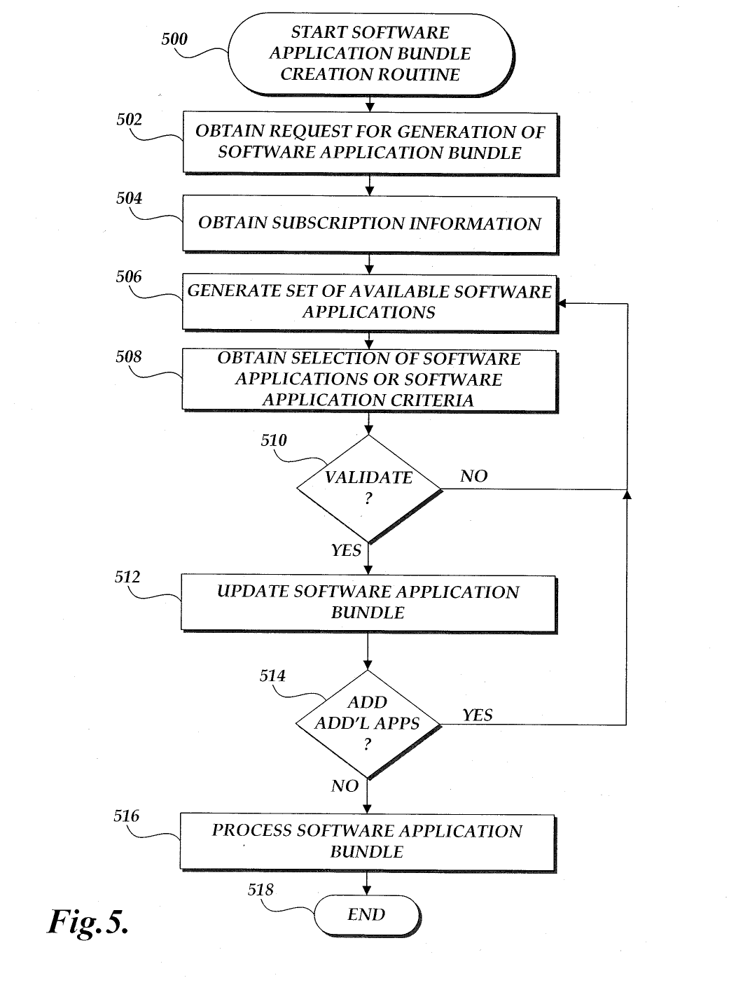

Turning now to FIG. 5, a software application bundle creation routine 500 will be described. Illustratively, routine 500 can be implemented by the management system 108 based on interactions with a client device 102. As previously described, aspects of routine 500 may be utilized for individual software application bundle creation or enterprise level software application bundle creation. At block 502, the management system 108 obtains a request for generation of a software application bundle. Illustratively, the client device 102 can transmit a request for generation of an application bundle, such as via an API or a request transmitted to a Web page associated with the management system 108.

At block 504, the management system 108 obtains subscription information associated with a user. In one embodiment, the request for creation of the software application bundles can include a selection of a subscription amount. In another embodiment, the management system 108 can obtain the selection of a subscription amount from other sources, such as via a user profile data store 114. As previously described, a user may be associated with a subscription fee that is associated, directly or indirectly, to a total sum that can be utilized to select software applications. The total sum does not necessarily equate to the subscription fee as the management system 108 may subtract reserve costs, usage fees, etc.

At block 506, the management system 108 generates a set of one or more software applications that may be included in a software application bundle. As previously indicated, software applications can be associated with various costs, such as credits, that are applied against the total sum when the software application is selected to be in a bundle. Illustratively, the management system 108 can utilize an iterative process to facilitate the selection of software applications for inclusion in a software application bundle. In some embodiments, a user can select individual software applications that are included in a software application bundle. In other embodiments, a user can modify the selection of software applications included pre-existing software application bundles or utilize a template of target software applications. At block 508, the management system 108 obtains a selection of specific software applications or criteria utilized to refine a search for specific software applications that can be further displayed to the user. The process continues until one or more software applications are selected.

At decision block 510, a test is conducted to determine whether the selection can be validated. In one aspect, the management system 108 can determine a cost attributed to each software application based on the reconciliation or distribution program or other criteria. Accordingly, the management system 108 can validate to determine whether sufficient credits are available to add the application. If not, the routine 500 can return to block 506 to allow the management system 108 can prompt a user to add or remove software application or increase subscription fees based on user selections. In another aspect, the management system 108 can validate whether the publisher 104 or management system 108 has associated any restrictions for the inclusion of the selected software application in the particular software application bundle (e.g., based on a template) or in combination with other software applications or types of software applications. For example, a publisher may indicate that its software application is not allowed to be combined with another software application that provides the same function.

If at decision block 510, the selected software application can be validated, at block 512, the management system 108 adds the software application to the current software application bundle. In one embodiment, the addition or removal of a software application can correspond to modifying a control that determines whether a software application in a software application bundle is considered active or otherwise accessible to the user. For example, a user can manipulate graphic controls that indicate the active or inactive status of a software application. In another embodiment, the addition or removal of a software application from a software bundle may correspond to the addition or removal of a listing of the software application.

At decision block 514, a test is conducted to determine whether additional software applications should be added. If so, the routine 500 returns to block 506. Alternatively, if no additional software applications should be added, at block 516, the management system 108 processes the completed software application bundle. In one embodiment, the management system 108 can transmit the confirmation to the client device 102 and one or more publishers 104 corresponding to the created software application bundle. In another embodiment, the management system 108 can publish the created software application bundle or aspects of the software application bundles to additional persons. For example, the management system 108 can publish the software applications included in a custom software application bundle to be utilized as a template for other users. In another example, the management system 108 can post the custom software application bundle on a Web page so that other users may subscribe. At block 518, the routine 500 terminates.

Turning now to FIG. 6, a software application usage processing routine 600 will be described. Illustratively, routine 600 can be implemented by the management system 108 based on usage data obtained from client devices 102 or publishers 104. At block 602, the management system 108 determines an event for distribution of at least a portion of the collected subscription fees or a reconciliation event. As previously described, in one embodiment, user access to software application bundles may be defined in terms of monthly subscription fees or credits. Accordingly, in this embodiment, that management system 108 may determine a reconciliation event to correspond to the period of the subscription, e.g., every month. In other embodiments, the management system 108 may determine additional or alternative reconciliation events, such as on fixed calendaring days, upon satisfying a number of use or access events, upon satisfying minimum or maximum thresholds, and the like.

At block 604, the management system 108 obtains usage information related to a subscription, distribution information related to a total sum to be distributed and reconciliation information related to the distribution program associated with the various software application bundles. At block 606, the management system 108 processes the collected usage information. In one embodiment, that management system 108, can process the collected usage information by applying one or more scalars. In one aspect, the management system 108 can multiple the usage information by a weighting function that can either increase or decrease the number of access events that will be counted. For example, the management system 108 can multiple the number of access events by a scaling factor for software applications determined to be a premium. In another example, the management system 108 can multiple the number of access events by a scaling factor for software applications based on time of day. In another aspect, the management system 108 can apply various filters to determine whether to count access events. In one example, the management system 108 can utilize frequency filters to determine a minimum number of access events that must occur prior to being part of the allocation. In another example, the frequency filters can be utilized to normalize specific outliers in which access events have increased or decreased relative to historical data for the software application or relative to other software applications in the software application bundles. In a further aspect, the management system 108 can utilize other statistical processes, such as normalization, averaging, extrapolation and the like to process the usage information. One skilled in the relevant art will appreciate that additional or alternative processing techniques may also be applied.

Illustratively, the management system 108 determines the appropriate allocation of the distribution amount corresponding to the subscription fee that will be distributed to the publishers 104 in the subscribed software application bundle by applying the various distribution or reconciliation programs for each software application. At block 608, the management system 108 identifies all software application programs subject to fixed cap or fixed fee distribution or reconciliation program. At block 610, the management system 108 subtracts the distribution amount by the sum of the fixed fee caps. At block 612, the management system 108 then determines the appropriate apportionment for any software application programs implementing a per usage distribution program or an average usage distribution program. The management system 108 then applies the determined distribution to the remaining funds/credit.

At block 614, the management system 108 transmits causes reconciliation. In one aspect, the management system 108 can transmit the reconciliation information to the publisher 104 to provide them with an accounting of the financial compensation or credits that have been allocated to the publisher. In another aspect, the management system 108 can transmit the reconciliation information to the client device 102 to provide an indication of how the subscription fees were allocated to various publishers 104. In still a further aspect, the management system 108 can transmit the reconciliation information to various third-party providers, such as financial institutions, to cause the reconciliation of financial compensation or credits. In still another aspect, the management system 108 can publish at least portions of the allocation information using various publication services or social networking services, such as to identify popular software applications, popular software application bundles or users of the software application bundles. At block 616, the routine 600 ends.

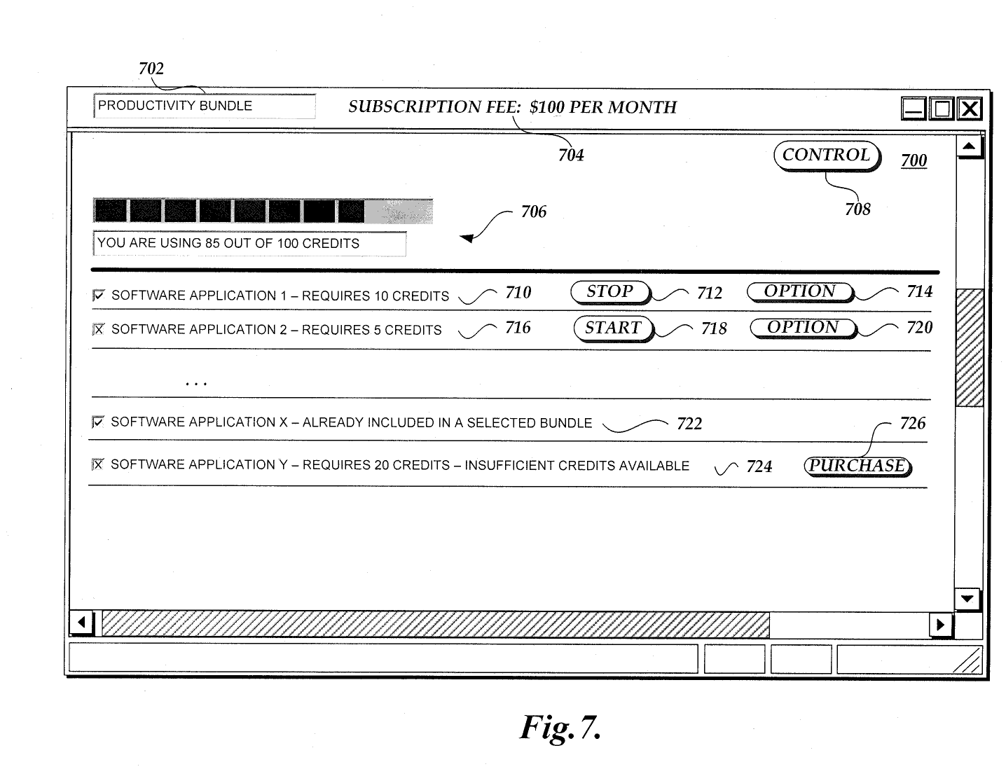

Turning now to FIG. 7, a block diagram illustrative of screen display 700 for facilitating the management of software applications in a custom software application bundle will be described. Illustratively, the screen display 700, or portions thereof, can be accessed by users to manage software application bundles. As illustrated in FIG. 7, the screen display 700 includes a first portion 702 for identifying the software application bundle and an associated cost 704, such as a subscription fee, virtual credit or fixed fee. The screen display 700 also includes a second portion 706 for tracking usage of the total sum available for the inclusion of software applications in the bundle. As previously discussed, the management system 108 may suggest additional funds if insufficient credit exists. The screen display also includes a control 708 that allows a user to control aspects of the software application bundle, such as privacy settings, sharing settings, etc. Illustratively, the control 708 will apply to all the software applications in the identified software application bundle.

In addition to information and controls for the software application, the screen display also includes various information and controls about the individual software applications that may be part of the software application bundle. For example, portion 710 identifies “Software Application 1” and the number of credits that have been applied by the management system 108. Additionally, control 712 allows a user to indicate that the software application should no longer be included or should be turned off in the software application bundle. Still further, option control 714 can illustratively allow a user to control aspects of the individual software application, such as privacy controls, sharing controls, etc. In another example, portion 716 identifies “Software Application 2” and the number of credits the inclusion of the software application would have to be applied by the management system 108 to add the software application to the software application bundle. Additionally, control 718 allows a user to indicate that the software application should be included in the software application bundle. Still further, option control 716 can illustratively allow a user to control aspects of the individual software application, such as privacy controls, sharing controls, etc.

As previously described, the management system 108 can also monitor the inclusion of software applications and prioritize which software applications are included in a software application bundle. As indicated in portion 722, the management system 108 can identify that a software application that would otherwise be available may be accessed via a different software application bundle. As illustrated in FIG. 7, the management system 108 can restrict access to prevent the addition of the duplicative software application bundle.

As also previously described, the screen display 700 can also include an identification of software application that cannot be added because of insufficient funds. In this example, portion 724 identifies “Software Application Y” and indicates the number of credits the inclusion of the software application would have to be applied by the management system 108 to add the software application to the software application bundle. Additionally, the screen display 700 includes the indication that additional credits/funds would be required and includes a control 726 to facilitate the purchase of additional credits or an increase in subscription fees.

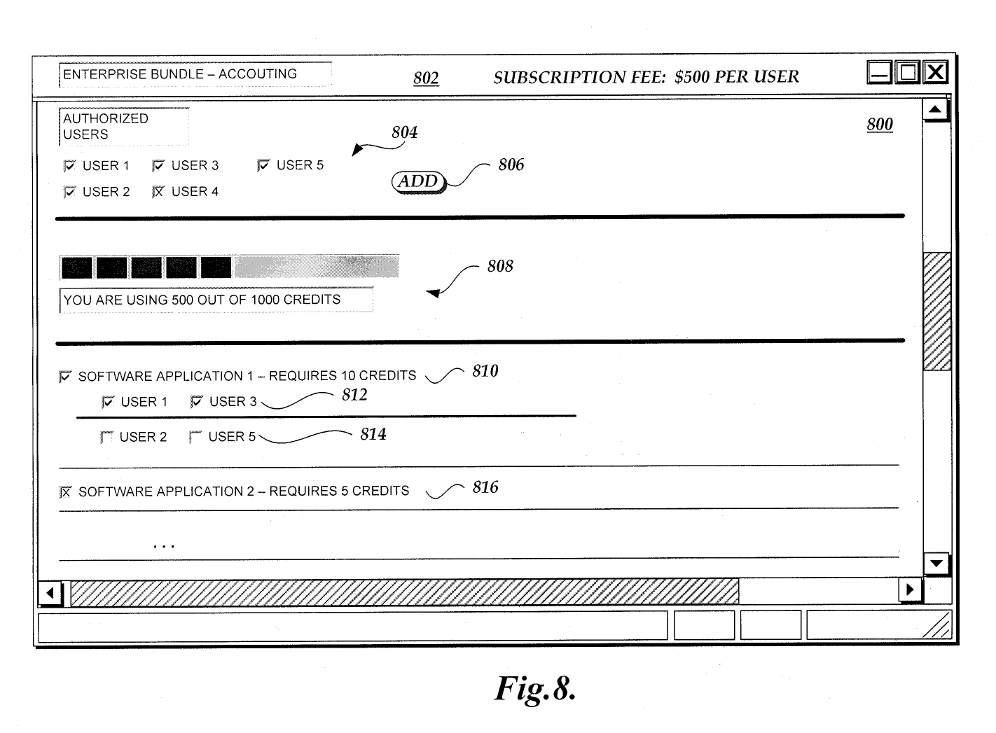

Turning now to FIG. 8, a block diagram illustrative of a screen display 800 for facilitating the management of software applications in an enterprise software application bundle will be described. Illustratively, the screen display 800, or portions thereof, can be accessed by users to manage software application bundles for enterprise users. As illustrated in FIG. 8, the screen display 800 includes a first portion 802 for identifying the software application bundle and an associated cost, such as a subscription fee, virtual credit or fixed fee.

The screen display 800 also includes a second portion 804 for tracking which users have been provided access to the enterprise software application bundle. Illustratively, users may be identified for inclusion by a control, such as control 806. Additionally, the management system 108 can also automatically process potential users for inclusion by applying different criteria, such as email address, client identifiers, contact information, etc.

The screen display 800 also includes a third portion 808 for tracking usage of the total sum available for the inclusion of software applications in the bundle. In addition to information and controls for the software application, the screen display also includes various information and controls about the individual software applications that may be part of the software application bundle. For example, portion 810 identifies “Software Application 1” and the number of credits that have been applied by the management system 108. It also includes a first set of controls 812 for managing users that have access to the software application via the software application bundle and a second set of controls 814 for managing users that have not selected, or been selected, to access the software application via the software application bundle. In another example, portion 816 identifies “Software Application 2” and the number of credits the inclusion of the software application would have to be applied by the management system 108 to add the software application to the software application bundle.

While illustrative embodiments have been disclosed and discussed, one skilled in the relevant art will appreciate that additional or alternative embodiments may be implemented within the spirit and scope of the present disclosure. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer-readable medium storing the computer executable components, such as a CD-ROM, DVD-ROM or network interface. Further, the component and/or data can be included in a single device or distributed in any manner. Accordingly, general purpose computing devices may be configured to implement the processes, algorithms, and methodology of the present disclosure with the processing and/or execution of the various data and/or components described above. Alternatively, some or all of the methods described herein may alternatively be embodied in specialized computer hardware. In addition, the components referred to herein may be implemented in hardware, software, firmware or a combination thereof.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A method for managing content comprising:
obtaining a request for accessing a software application bundle, wherein the software application bundle corresponds to two or more software applications and wherein a first software application of the two or more software applications is associated with a first reconciliation program and a second software application two or more software applications is associated with a second reconciliation program;
obtaining usage information corresponding to access of at least one of the two or more software applications;
processing the usage information based on application of at least one scalar to the usage information;
processing a total amount to be distributed based on the processed usage information by associating terms associated with the first reconciliation program and terms associated with the second reconciliation program; and
causing reconciliation of the total amount to be distributed.

2. The method as recited in claim 1, wherein obtaining usage information includes obtaining usage information from a provider of the two or more software applications.

3. The method as recited in claim 1, wherein processing the usage information based on application of at least one scalar includes applying at least one multiplier to the usage information.

4. The method as recited in claim 1, wherein processing the usage information based on application of at least one scalar includes applying at least one filter to the usage information.

5. The method as recited in claim 1, wherein processing the usage information based on application of at least one scalar includes applying at least one statistical process to the usage information.

6. The method as recited in claim 1, wherein the total amount to be distributed corresponds to a portion of a subscription fee associated access to the software application bundle.

7. The method as recited in claim 1, wherein obtaining a request for accessing a software application bundle includes obtaining a configuration of a software application bundle.

8. The method as recited in claim 7, wherein obtaining the configuration of the software application bundle includes obtaining a selection of software applications based on credits associated with each software application bundle.

9. The method as recited in claim 1, wherein causing reconciliation of the total amount to be distributed includes causing a crediting of an account associated a publisher.

10. The method as recited in claim 1, wherein causing reconciliation of the total amount to be distributed includes publishing reconciliation information.

11. A method for managing content comprising:
obtaining usage information corresponding to access of a software application bundle, wherein the software application bundle corresponds to two or more software applications;
processing the usage information based on application of at least one scalar to the usage information;
processing a total amount to be distributed based on the processed usage information by associating terms associated with reconciliation programs associated with each of the two or more software applications, wherein at least two of the reconciliation programs are different; and
causing reconciliation of the total amount to be distributed.

12. The method as recited in claim 11, wherein obtaining usage information includes obtaining usage information from a provider of the two or more software applications.

13. The method as recited in claim 11, wherein processing the usage information based on application of at least one scalar includes applying at least one multiplier to the usage information.

14. The method as recited in claim 11, wherein processing the usage information based on application of at least one scalar includes applying at least one filter to the usage information.

15. The method as recited in claim 11, wherein processing the usage information based on application of at least one scalar includes applying at least one statistical process to the usage information.

16. The method as recited in claim 11 further comprising obtaining a configuration of a software application bundle.

17. The method as recited in claim 16, wherein obtaining the configuration of the software application bundle includes obtaining a selection of software applications based on credits associated with each software application bundle.

18. A system for managing content comprising:
a management system, implemented on a computing system, the management system operable to:
obtain usage information corresponding to access of a software application bundle, wherein the software application bundle corresponds to two or more software applications;
process usage information based on application of at least one scalar to the usage information;
process a total amount to be distributed based on the processed usage information by associating terms associated with reconciliation programs associated with each of the two or more software applications, wherein at least two of the reconciliation programs are different; and
cause reconciliation of the total amount to be distributed.

19. The system as recited in claim 18, wherein the management system is further operable to process the usage information based on application of at least one scalar, the at least one scalar corresponding to at least one multiplier to the usage information, at least one filter to the usage information or at least one statistical process to the usage information.

20. The system as recited in claim 18, wherein the management system is further operable to causing reconciliation of the total amount to be distributed includes cause a reconciliation upon expiration of a subscription period.
